(19) United States
(12) Patent Application Publication
(10) Pub. No.: US 2002/0150244 A1
(43) Pub. Date: Oct. 17, 2002

(54) Method of controlling transmission and reception of data including encrypted data stream

(76) Inventors: Byung-jun Kim, Gyeonggi-do (KR); Jung-wan Ko, Gyeonggi-do (KR)

Correspondence Address: STAAS & HALSEY LLP, 700 11TH STREET, NW, SUITE 500, WASHINGTON, DC, 20001, US

(21) Appl. No.: 10/103,892

(22) Filed: Mar. 25, 2002

(30) Foreign Application Priority Data
Mar. 26, 2001 (KR) 2001-15639

(51) Int. Cl. H04N 7/167

(52) U.S. Cl. 380/201

(57) ABSTRACT

A method of transmitting and receiving encryption channels which are needed to be encrypted includes encrypting only a part of channel data to be encrypted and transmitting the encrypted part in a predetermined streaming method, and inserting a key to decode the encrypted stream into an adjacent non-encrypted stream and transmitting the stream. The decoding key is extracted from the adjacent stream and decoding the encrypted data stream using the decoding key to reproduce the streams. According to the method, by using the selective encryption method for data streams, paid data can be safely transmitted in a variety of business model systems, and additional copying the encrypted data which is accessed and reproduced can be prevented.

### CROSS-REFERENCE TO RELATED APPLICATION

This application claims the benefit of Korean Application No. 2001-15639, filed Mar. 26, 2001, in the Korean Intellectual Property Office, the disclosure of which is incorporated herein by reference.

### BACKGROUND OF THE INVENTION

1. Field of the Invention

The present invention relates to a method of controlling transmission and reception of data, and more particularly, to a method of controlling transmission and reception of data, including encrypted data, in which data streams are selectively encrypted, transmitted, and accessed, according to a type of the data stream to be transmitted and business models for using the data.

2. Description of the Related Art

As digital broadcast has begun and digital media have been spread, a variety of copy-prevention technologies and apparatuses have been developed. In general, however, the technologies and apparatuses are applied to a single streaming method or applied regardless of the kinds of data streams.

For example, encryption technologies used to encrypt data to prevent data from being copied are usually applied to a Digital Versatile Disc (DVD). According to the ordinary data encryption technologies, all of the data or a part of data is encrypted and recorded on a DVD. When the data is reproduced, the encrypted data is decoded and then displayed on a screen, but the encrypted data cannot be directly copied. These encryption technologies can be applied to other data recording media.

There are also access control methods in which, in order to access a medium on which the encrypted data is recorded, a smart card which has a right to access the medium is used, password input is needed, or a central system directly controls an apparatus that reproduces encrypted data from the medium.

In a digital broadcast, there are standards for paid broadcast which use encryption methods. However, the standards are for a single streaming method, and therefore there are limits in using the standards in a variety of business models.

In these encryption transmission methods, the data may not be protected when the methods are applied to an additional business model, or when data is once decoded and then stored. Also, since the data streams are decoded always using the same key information, problems may take place in the safety of data protection.

### SUMMARY OF THE INVENTION

To solve the above and other problems, it is an objective of the present invention to provide a method of controlling transmission and reception of data, including encrypted data, in which a data stream is selectively encrypted, transmitted, and accessed according to a type of data stream to be transmitted or a type of business model being used.

Additional objects and advantages of the invention will be set forth in part in the description which follows and, in part, will be obvious from the description, or may be learned by practice of the invention.

To accomplish the above and other objectives of the present invention, an image information transmission method according to an embodiment of the invention includes transmitting channel data including encrypted image information in a first stream together with non-encrypted channel data in a second stream using a multiple streaming method, where a key to decode the encrypted channel data is inserted into the non-encrypted data prior to transmission, and the non-encrypted channel is adjacent to the encrypted channel.

According to an aspect of the invention, for the stream having the encrypted channel data, only a part of the stream data is not encrypted prior to transmission.

According to another aspect of the invention, all of the data in the stream having the encrypted channel is encrypted prior to transmission.

According to another embodiment of the present invention, an image information transmission method includes encrypting only a part of channel data to be encrypted and transmitting the channel data in one stream using a predetermined streaming method in which a key to decode the encrypted channel data is inserted into a non-encrypted part of the channel data in the same channel and is transmitted in the one stream.

According to a further embodiment of the present invention, a method of transmitting and receiving encryption channels includes encrypting only a part of channel data to be encrypted and transmitting the encrypted part as an encrypted stream in a predetermined streaming method, inserting a key to decode the encrypted stream into a non-encrypted stream adjacent to the encrypted stream and transmitting the adjacent stream, extracting the key from the adjacent non-encrypted stream, decoding the encrypted stream using the key, and reproducing the decoded and non-encrypted streams.

According to a yet further embodiment of the present invention, a method of storing and reproducing encrypted data in which an encrypted data stream and a non-encrypted data stream are transmitted in a streaming method, stored/written on a recording medium, and reproduced, the method includes extracting a key used to decode the encrypted stream and storing the extracted key in a predetermined area of the recording medium, storing the encrypted and non-encrypted streams on a data area of the recording medium, and decoding the encrypted streams using the stored key during reproduction of the encrypted stream.

According to an aspect of the invention, the predetermined area of the recording medium is an area where it is impossible for a user to access and copy data so as to prevent the stored encrypted stream from being copied to the another medium and/or reproduced from the another medium.

According to a still yet further embodiment of the present invention, a method of transmitting and receiving content including advertisement content and content desired by the user are transmitted and received, the method includes encrypting the desired content while not encrypting the advertisement content, inserting a key needed to decode the encrypted content in non-encrypted streams corresponding to the advertisement content, placing the non-encrypted streams having the advertisement content and the key before encrypted streams having the encrypted desired content and transmitting the non-encrypted and encrypted streams, if the advertisement content is received and viewed, extracting the key from the non-encrypted streams, and decoding the encrypted content using the key.

According to an aspect of the invention, the key comprises partial keys that are distributed within the advertisement content by being inserted into corresponding parts of the advertisement content so that the user views the advertisement content for a predetermined time in order to obtain the key.

### BRIEF DESCRIPTION OF THE DRAWINGS

The above and other objects and advantages of the present invention will become more apparent and more readily appreciated by describing in detail embodiments thereof with reference to the accompanying drawings in which:

FIGS. 1A and 1B are diagrams of formats used in the transmission or recording of multiple streams of data;

FIGS. 2A and 2B are diagrams of data transmission formats according to an embodiment of the present invention in which only a selected channel is encrypted and then transmitted or recorded using the transmission or recording format for the multiple streams of data as shown in FIGS. 1A and 1B;

FIG. 3 is a block diagram showing a method of selectively encrypting the multiple streams according to an embodiment of the present invention;

FIG. 4 is a diagram of a transmission format for an encrypted data stream of another embodiment of the present invention;

FIG. 5 is a diagram of a selective encryption transmission format for multiple data streams according to a further embodiment of the invention;

FIG. 6 is a block diagram showing a process of transmitting and reproducing an encrypted data stream as shown in FIG. 5;

FIG. 7 is a detailed block diagram showing a process at the receiving side to control access to the encrypted stream when transmission is controlled as shown in FIG. 6;

FIG. 8 is a flowchart of a control method of recording and reproducing data on an only-once-recording-type medium on which is data is recorded such that the data can be reproduced but cannot be again copied; and

FIG. 9 is a drawing of a device to reproduce the multiple streams data from a recording medium according to an embodiment of the invention.

### DESCRIPTION OF THE EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

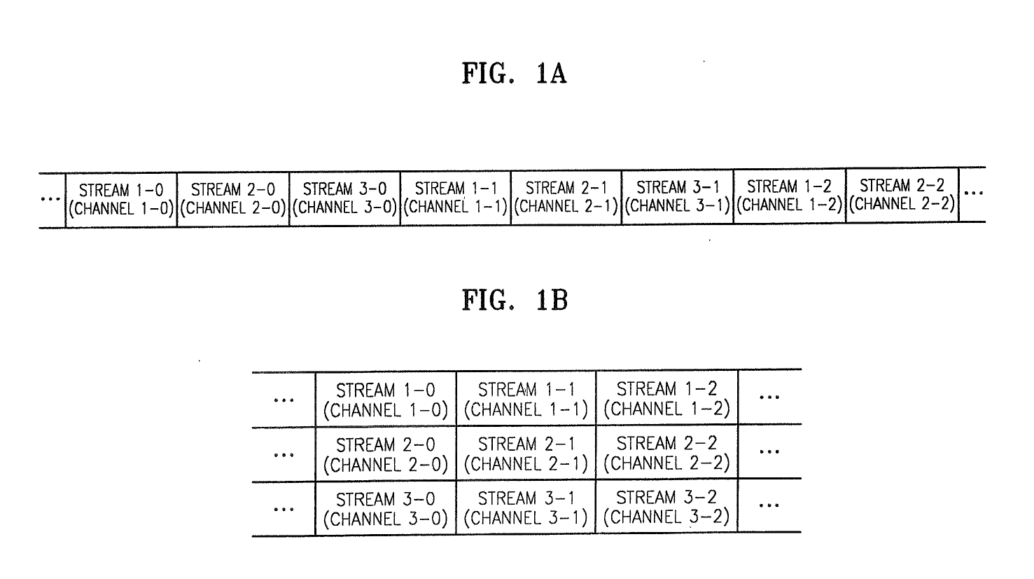

FIG. 1A is an example of a transmission format for multiple streams using time division. Three channels (i.e., channel 1, channel 2, and channel 3) are time-divided to form stream data. The channels include channel 1-0, channel 2-0, channel 3-0, channel 1-1, channel 2-1, channel 3-1, channel 1-2, channel 2-2, and so forth. The time-divided stream data is recorded and transmitted. FIG. 1B is an example of a transmission format for the multiple streams using frequency division. The three channels 1, 2, 3 are frequency-divided, and then recorded or transmitted.

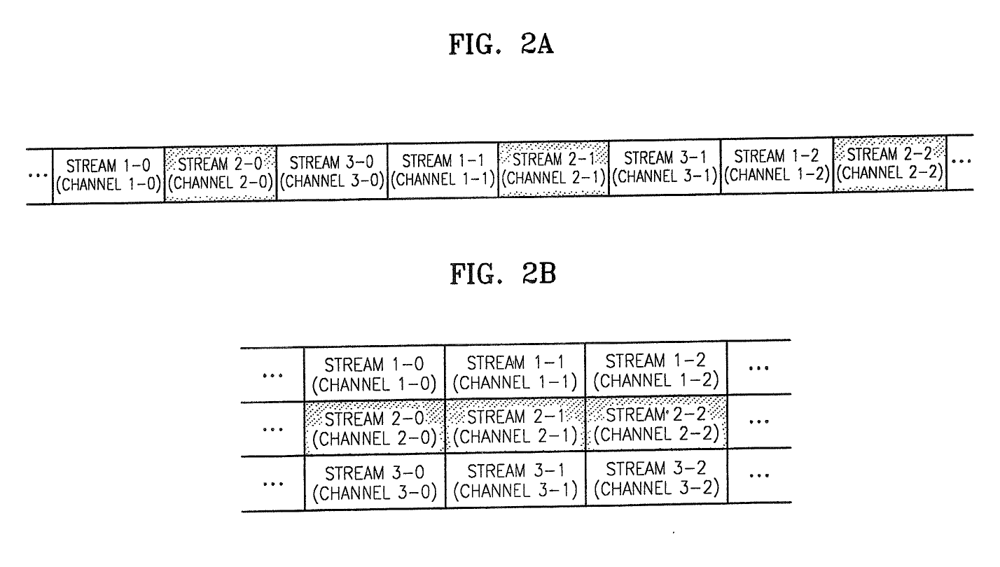

FIGS. 2A and 2B are diagrams of data transmission formats according to an embodiment of the present invention. As shown, only a selected channel, channel 2, is encrypted and then transmitted or recorded using the multiple stream formats shown in FIGS. 1A and 1B. Key information, which is used to decode the encrypted channel 2 in FIGS. 2A and 2B, is inserted into the data stream including the encrypted channel 2, and transmitted, or is otherwise given or provided before transmitting the data stream including the encrypted channel 2 so as to allow decoding of the encrypted channel 2 when the data stream is received.

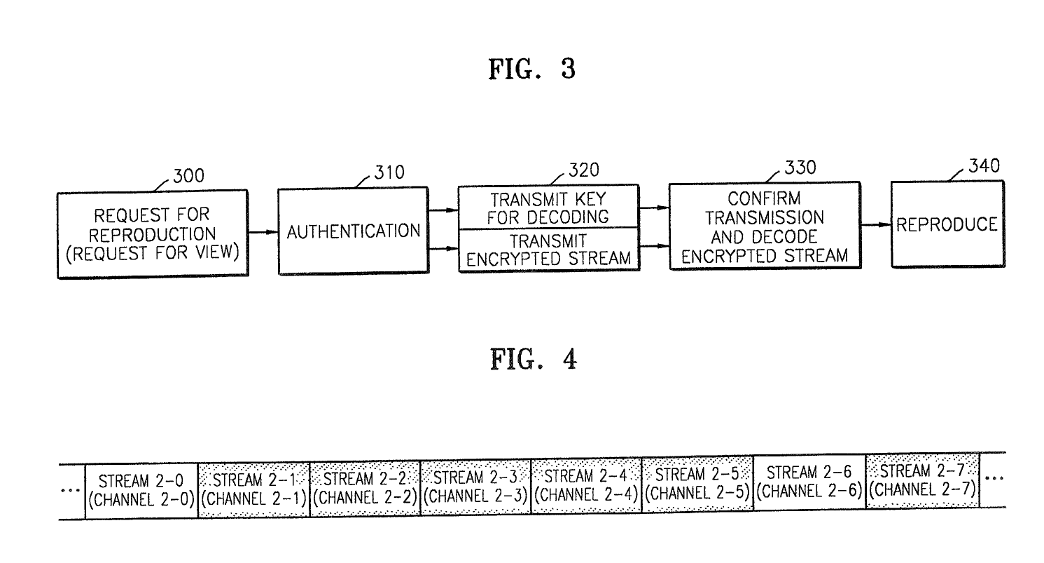

FIG. 3 is a block diagram showing a selective encryption transmission method for use with multiple streams of data according to an embodiment of the present invention. First, if a request for reproduction or viewing is received in operation 300, a process for authentication of the requester is performed in operation 310. If the authentication is successful, an access right is given to the requester, and a decoding key and encrypted streams of data are transmitted in operation 320. The authentication operation 310 is performed between a site responsible for transmission, such as a broadcasting station, and a receiving terminal.

As shown in FIG. 9, when the streams are recorded on a medium 10, the authentication is performed between a part 100 used to read data from the medium and a part 200 used to reproduce the data from the medium 10. Transmission of the decoding key and the encrypted data streams is done by the reading part 100 reading data from the medium 10 and transmitting the read data to the reproducing part 200 in a manner similar to how the broadcasting station transmits to the receiving terminal.

The decoding key may be transmitted separately or may be hidden in the streams and then transmitted. The receiving terminal or the reproducing part 200 receives and confirms the transmitted decoding key and encrypted data streams, decodes the encrypted data in operation 330, and then begins to reproduce (or view) the decoded data in operation 340.

FIG. 4 is a diagram of a transmission format for an encrypted data stream of another embodiment of the present invention. This format shows only one channel that has been de-multiplexed after transmission. Here, unlike conventional methods, a decoding key is inserted into predetermined parts (streams 2-0 and 2-6) of the channel and then transmitted. Unless the predetermined parts are received and reproduced (or viewed), the receiving side cannot reproduce the remaining part of the channel. In this case, by inserting different keys into streams 2-0 and 2-6, encrypted data streams can be more safely protected because one decoding key cannot decode the entire encrypted data stream. In addition, the decoding keys can be frequently changed as the data streams are transmitted.

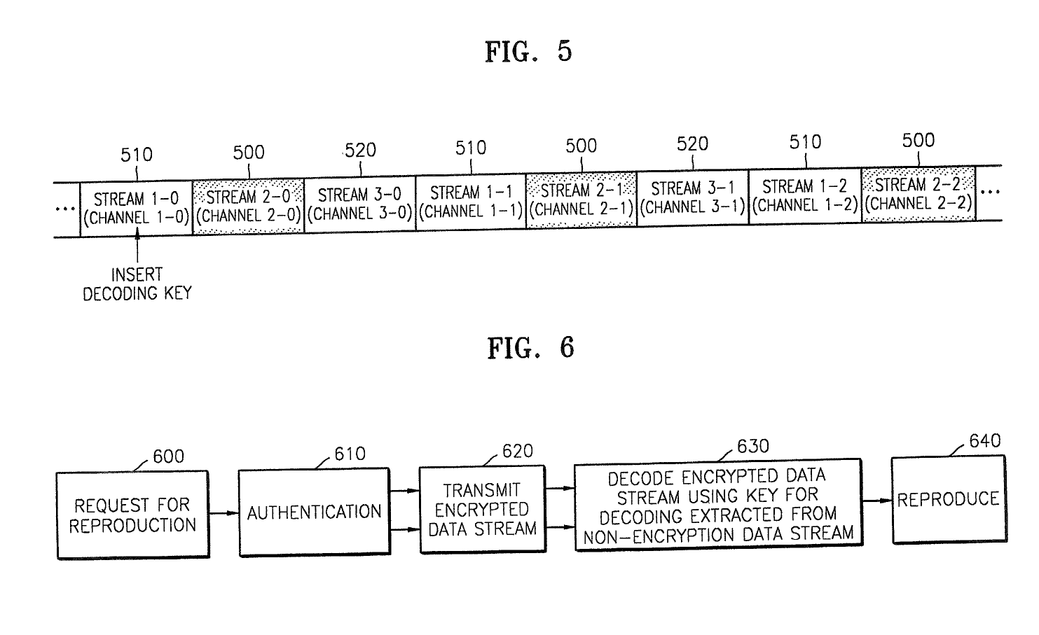

FIG. 5 is a diagram of an example of a selective encryption transmission format for multiple data streams according to a further embodiment of the invention. In this transmission method, a decoding key for a stream (stream 2) 500 which is desired to be encrypted is included in an adjacent stream 510 or 520 ( i.e., stream 1 or stream 3) and then transmitted. As shown, the adjacent stream is stream 510. According to this embodiment, it is possible to encrypt the transmission for use in a variety of business models, a key to decode the encrypted streams is not separately transmitted, and, in order to protect data to be encrypted, the information of a key can be changed arbitrarily during transmission of the multiple streams. Also, since the decoding key is hidden in the adjacent stream 510 and transmitted, the decoding key cannot be obtained except when the decoding key is recorded with the adjacent stream 510 (also except when streams 1 through 3 are being broadcast). Therefore, it is impossible to record and reproduce or copy only stream 2 since stream 2 lacks the decoding key. While shown as being in an adjacent stream (stream 1 or stream 3), it is understood that the decoding key can be included in any stream, adjacent or non-adjacent, that is not the stream 2.

FIG. 6 is a block diagram showing a process of transmitting and reproducing an encrypted data stream as shown in FIG. 5. After a request for reproduction (or viewing) is received in operation 600, the transmitting side or the broadcasting station performs an authentication process which determines whether or not to allow data reproduction by the requester in operation 610. Authentication is performed through a predetermined confirmation procedure between the transmitting side and the receiving side. After the authentication, the transmitting side transmits encrypted data streams in operation 620. The receiving side confirms that the encrypted streams are transmitted, decodes the encrypted streams using a decoding key in operation 630 and begins to reproduce the decoded data in operation 640.

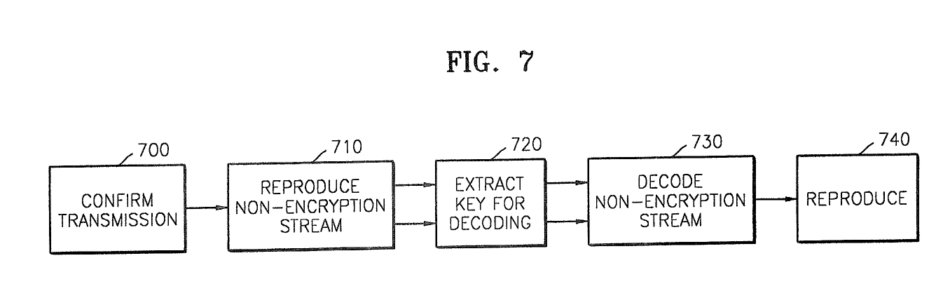

FIG. 7 is a detailed block diagram showing a process in the receiving side for controlling access to the encrypted stream under the transmission control as shown in FIG. 6. The transmitted encrypted streams are confirmed in operation 700, and the non-encrypted streams are reproduced in operation 710. A key for decoding the encrypted streams is extracted from the non-encrypted streams in operation 720. Using the extracted decoding key, the encrypted streams are decoded in operation 730. The decoded streams are reproduced in operation 740.

According to an embodiment of the present invention, the methods of encryption and accessing the encrypted data of FIGS. 6 and 7 includes placing advertisements in the non-encrypted streams. Broadcast programs needed or desired by users are placed in the encrypted streams. As such, the decoding key can be extracted only after receiving the advertisements in the non-encrypted streams. Using the decoding key, the encrypted streams, which are transmitted after the advertisements, can be decoded. Thus, after viewing the advertisements for a predetermined time, the encrypted broadcast program can be viewed without charge. In this way the methods shown in FIGS. 6 and 7 can be utilized in the broadcasting businesses.

Specifically, while a user watches non-encrypted streams corresponding to advertisements, the decoding key is read. The decoding key is hidden or encrypted in the non-encrypted streams, is hidden in watermarks in the advertisements, and the like. Using the decoding key, the encrypted streams of a predetermined channel which is received after the non-encrypted streams can be decoded.

According to an embodiment of the invention, if, in order to reproduce the desired content, a user receiving the non-encrypted streams of an advertisement channel is required to watch the advertisements for a predetermined time, the transmitting side inserts the key into the non-encrypted advertisement channel streams at predetermined intervals. The transmitting side then sends the non-encrypted streams and the following encrypted channel streams. Then, the user can obtain the key to decode the adjacent encrypted streams only after receiving the advertisements for a predetermined time.

This transmission method can be used by various business models. For example, providers of charged sport game broadcasting programs can insert advertisements between sport broadcasts, and after watching the advertisements for a predetermined time, the viewers can reproduce the sport broadcasts or desired interactive elements contained therein. Further, providers of distance learning could require the viewing of a lesson and/or the taking of testing material, and after viewing the lesson and/or taking the test, allow the user to decode desired information (e.g., play an encrypted game, watch an encrypted movie, or reproduce encrypted music). In addition, providers of digital media such as music and movies could insert the changing decoding keys during broadcast of the digital media to an authenticated user so as to prevent unauthorized use at increased levels of security.

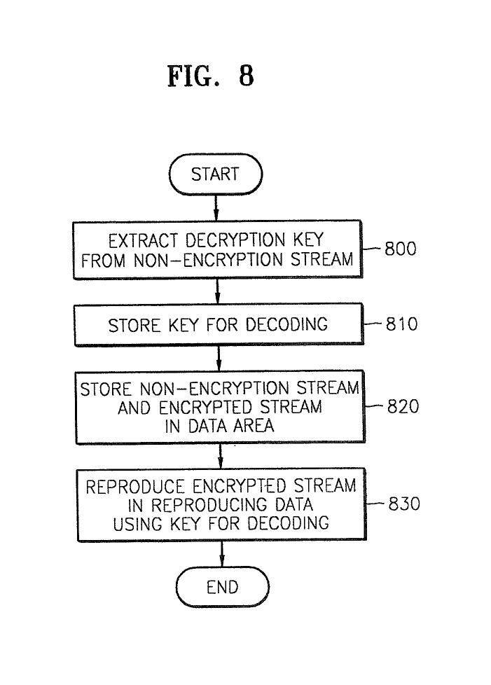

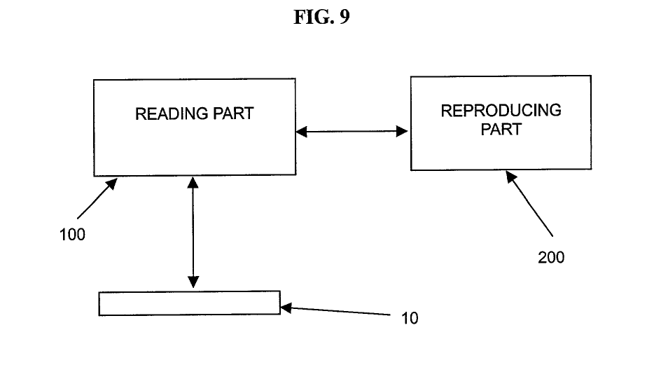

FIG. 8 is a flowchart showing a method of recording and reproducing data on an only once recording-type medium. In this type of medium, if data is recorded, data can be reproduced but cannot be copied again. When received data streams are recorded (written) on the medium for the first time, a decoding key is read from non-encrypted data streams, and a data area in which the decoding key was stored is changed to have a meaningless value in operation 800. The extracted decoding key is stored in a predetermined area of the medium in operation 810. The predetermined area should be an area to which users cannot access or in which users cannot modify data. Both the non-encrypted data streams and the encrypted data streams are recorded on a data recording area of the medium in operation 820. When data is reproduced, the decoding key stored in the predetermined area is used so that the encrypted data streams can be decoded in operation 830. While the decoding key is shown being recorded on the predetermined area that is on the same medium as the data area that stores the encrypted and non-encrypted data, it is understood that the predetermined area could also be on another medium that does not store the encrypted and non-encrypted data.

Whenever an encrypted data stream is recorded, a corresponding decoding key can be stored. Thus, a plurality of different decoding keys can be stored for corresponding parts of the encrypted data stream. When the content of the medium on which the encrypted data streams are recorded is attempted to be copied onto another medium or apparatus, the non-encrypted data streams or encrypted data streams recorded on the data recording area can be copied, but the decoding key stored in the predetermined area cannot be copied. Therefore, while the encrypted data streams can be copied to the other media, without the decoding key, the encrypted data streams cannot be reproduced.

According to an embodiment of the present invention, a transmission (recording) method of broadcasting or transmitting data on a medium is provided in which the distribution, broadcast, or the access to additional paid information is easily controlled. Encrypted data streams are used as additional information which can be viewed only when a charge is paid or when a condition for viewing is met. A decoding key to decode the encrypted data streams is inserted into an adjacent non-encrypted data stream. If the receiving side wants to decode and view the encrypted data streams, the receiving side pays the charge on-line or off-line and receives a needed key, card, and/or password. The value obtained at this time is the needed value to obtain the decoding key to decode the encrypted data streams. In this way, the encrypted data streams are double encrypted, which prevents the encrypted data streams from being viewed even though the decoding key is obtained from the non-encrypted stream.

According to the method of the present invention, by using the selective encryption method for data streams, paid data can be safely transmitted in a variety of business model systems, and unauthorized copying the encrypted data which is accessed and reproduced can be prevented.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is

1. An image information transmission method comprising:
inserting a key into non-encrypted channel data included in a first stream;
transmitting encrypted channel data including encrypted image information in a second stream together with the non-encrypted channel data in the first stream using a multiple streaming method,
wherein:
the key is needed to decode the encrypted channel data and,
during transmission, the first stream is adjacent to the second stream.

2. The method of claim 1, wherein among the encrypted channel data, a part of the second stream includes channel data that is not encrypted.

3. The method of claim 1, wherein the second stream does not include non-encrypted data.

4. An image information transmission method comprising:
encrypting a part of channel data to be encrypted;
inserting a key to decode the encrypted part of the channel data into a non-encrypted part of the channel data; and
transmitting the encrypted and non-encrypted parts of the channel data as multiple streams of data using a predetermined streaming method,
wherein the non-encrypted part of the channel data having the key and the encrypted part of the channel data are in a same channel during transmission.

5. A method of transmitting and receiving encryption channels which are needed to be encrypted, comprising:
encrypting a part of channel data to be encrypted and transmitting the encrypted part in a first stream;
inserting a key to decode the encrypted part of the channel data into a non-encrypted second stream of data adjacent the first stream;
transmitting the first and second streams using a predetermined streaming method;
extracting the key from the adjacent non-encrypted stream; and
decoding the encrypted stream using the key and reproducing the decoded and non-encrypted streams.

6. A method of storing and reproducing encrypted data wherein an encrypted data stream and a non-encrypted data stream are transmitted in a streaming method, stored (written) on a recording medium, and reproduced from the recording medium, the method comprising:
extracting a key to decode the encrypted stream from the transmitted data streams and storing the extracted key in a predetermined area on the recording medium;
storing the transmitted encrypted stream and the non-encrypted stream on a data area of the recording medium; and
decoding the encrypted stream using the stored key.

7. The method of claim 6, wherein the predetermined area of the recording medium on which the key is stored is an area that a user cannot access and copy data so that the data in the encrypted stream cannot be copied to another medium and reproduced from the another medium.

8. A method of transmitting and receiving advertisement content and content desired by a user, the method comprising:
encrypting the desired content to be transmitted in a first stream;
inserting a key needed to decode the encrypted content in other streams corresponding to the non-encrypted advertisement content;
placing the other streams including the advertisement content having the key before the first stream including the encrypted content;
transmitting the first and other streams;
if the advertisement content of the transmitted other streams is received and viewed, extracting the key; and
decoding the transmitted encrypted content using the extracted key.

9. The method of claim 8, wherein the key comprises key parts that are distributed at predetermined parts of the advertisement content so that the advertisement content is viewed for a predetermined time.

10. A method of transmitting encrypted data and non-encrypted data, comprising:
encrypting portions of a first channel of data;
transmitting the first channel and a second channel of data using a format for multiple streams, where one portion of one of the first and second channels is not encrypted; and
providing a key such that, when received, the encrypted portions of the received first channel are decoded using the key.

11. The method of claim 10, wherein said providing the key comprises transmitting the key separately from the transmitted multiple streams.

12. The method of claim 11, further comprising authenticating a receiving terminal prior to said transmitting the key.

13. The method of claim 11, wherein said transmitting the key further comprises reading the key from a recording medium.

14. The method of claim 13, wherein said transmitting the first and second channels in multiple stream format further comprises reading the multiple stream format from a recording medium.

15. The method of claim 10, wherein said providing the key comprises inserting the key into the one non-encrypted portion prior to said transmitting the first and second channels in multiple stream format.

16. The method of claim 15, wherein the key is missing a value required to decode the encrypted portions of the first channel, and the method further comprising, after a predetermined condition is satisfied, transmitting the value to complete the key in order to allow the encrypted portions of the first channel to be decoded.

17. The method of claim 10, wherein the key comprises key parts, the first channel further comprises additional non-encrypted portions, and said providing the key comprises inserting the key parts in corresponding ones of the non-encrypted portions of the first channel prior to said transmitting the first and second channels in multiple stream format.

18. The method of claim 10, wherein the key comprises key parts, the second channel further comprises additional non-encrypted portions, and said providing the key comprises inserting the key parts distributed in corresponding ones of the non-encrypted portions of the second channel prior to said transmitting the first and second channels in multiple stream format.

19. The method of claim 10, further comprising hiding the key in the one non-encrypted portion prior to said transmitting the first and second channels in multiple stream format.

20. The method of claim 19, wherein the key is hidden as a watermark.

21. The method of claim 10, wherein:
the key comprises first and second key parts to be distributed in corresponding non-encrypted portions of one of the first and the second channel,
said encrypting the portions of the first channel comprises encrypting ones of the portions to be decoded using the first key part and encrypting others of the portions to be decoded using the second key part; and
the first key part cannot decode the other encrypted portions to be decoded using the second key part.

22. A method of reproducing encrypted data and non-encrypted data, comprising:
receiving first and second channels of data as first and second streams in multiple stream format, the first channel including encrypted portions and one of the first and second channels including a non-encrypted portion; and
decoding the encrypted portions using a key.

23. The method of claim 22, further comprising extracting the key from the non-encrypted portion prior to said decoding the encrypted portions of the received first channel.

24. The method of claim 22, wherein the second channel is not encrypted and includes the non-encrypted portion from which the key is extracted, and the method further comprising reproducing the received non-encrypted second channel prior to reproducing the decoded portions of the received first channel.

25. The method of claim 22, wherein the first channel includes the non-encrypted portion from which the key is extracted, and the method further comprising extracting the key from the non-encrypted portion prior to said decoding the encrypted portions of the received first channel.

26. The method of claim 25, further comprising reproducing the received non-encrypted portion prior to reproducing the decoded portions of the received first channel.

27. The method of claim 22, wherein the first channel further comprises additional non-encrypted portions, the key comprises key parts distributed in corresponding ones of the additional non-encrypted portions, and the method further comprising extracting the key parts from the corresponding ones of the additional non-encrypted portions to produce the key to decode the encrypted portions of the first channel.

28. The method of claim 22, wherein the second channel further comprises additional non-encrypted portions, the key comprises key parts distributed in corresponding ones of the additional non-encrypted portions, and the method further comprising extracting the key parts from the corresponding ones of the additional non-encrypted portions to produce the key to decode the encrypted portions of the first channel.

29. The method of claim 28, further comprising reproducing the non-encrypted second channel and the decoded portions of the first channel,
wherein the key parts are distributed at predetermined intervals such that the second channel is reproduced for a predetermined period of time prior to reproducing the decoded portions of the first channel.

30. The method of claim 22, wherein the key is missing a value required to decode the encrypted portions of the first channel, and the method further comprising, after satisfying a predetermined condition, receiving the value to complete the key to allow said decoding the encrypted portions of the first channel.

31. The method of claim 30, further comprising extracting the key missing the value from the non-encrypted portion.

32. The method of claim 22, further comprising recording the received multiple streams on a recording medium prior to said decoding the encrypted portions of the received first channel.

33. The method of claim 32, further comprising:
extracting the key from a data area in the non-encrypted portion prior to said recording the received multiple streams;
recording the extracted key in a predetermined portion of the recording medium; and
changing the data area from which the key was extracted to a meaningless value prior to said recording the non-encrypted portion on the recording medium during said recording the transmitted multiple streams.

34. A recording medium comprising:
a data part to store first and second channels of data encoded as first and second streams in a multiple stream format, the first channel comprising encrypted portions and one of the first and second channel data comprises a non-encrypted portion; and
a predetermined part to store key information used to decode the encrypted portions of the first channel.

35. The recording medium of claim 34, wherein the multiple stream format comprises a format using time-division of the first and second streams.

36. The recording medium of claim 34, wherein the multiple stream format comprises a format using frequency-division of the first and second streams.

37. The recording medium of claim 34, wherein said predetermined part comprises an area from which the stored key information cannot be copied.

38. The recording medium of claim 37, wherein:
the stored key information was extracted from a key area in the non-encrypted portion prior to the multiple streams being recorded on said data part, and
the key area is recorded in said data part with a meaningless value that does not allow decoding of the encrypted portions of the first channel.

39. The recording medium of claim 38, wherein the stored key information is a first partial key that requires use of a second partial key in order to decode the encrypted portions of the first channel.

40. The recording medium of claim 34, wherein the second channel does not include encrypted portions.

41. The recording medium of claim 34, wherein the first channel includes the non-encrypted portion.

42. A reproducing device to reproduce a recording medium that stores first and second channel data encoded as first and second streams in a multiple stream format, the first channel comprising encrypted portions, one of the first and second channels comprises a non-encrypted portion, and key information used to decode the encrypted portions of the first channel, comprising:
a reading part to read the first and second streams in multiple stream format and to read the key information from the recording medium; and
a reproducing part to separate the first and second streams from the read multiple stream format, to decode the encrypted portions of the first channel using the read key information, and to output the first and second streams as reproduced first and second channel data.

43. The reproducing device of claim 42, wherein said reproducing part de-multiplexes the first and second streams to separate the first and second streams from the multiple stream format.

44. The reproducing device of claim 43, wherein the multiple stream format comprises a format using time-division of the first and second streams.

45. The reproducing device of claim 43, wherein the multiple stream format comprises a format using frequency-division of the first and second streams.
